(19) United States
(12) Patent Application Publication
(10) Pub. No.: US 2012/0095904 A1
(43) Pub. Date: Apr. 19, 2012

(54) COMPUTER SYSTEM AND COMPUTER-IMPLEMENTED METHOD FOR MANAGING A FINANCIAL PRODUCT

(75) Inventors: Masaaki Katsuyama, Tokyo (JP); Albert Otto Selius, Larchmont, NY (US)

(73) Assignee: SWISS REINSURANCE COMPANY, ZUERICH (CH)

(21) Appl. No.: 12/676,608

(22) PCT Filed: Sep. 5, 2007
(86) PCT No.: PCT/CH07/00440

§ 371 Date: Nov. 21, 2011

(51) Int. Cl. G06Q 40/06

(52) U.S. Cl. 705/39

(57) ABSTRACT

For managing a financial product linked to an insurance event, the product provider (10) receives from an investor (30) a principal payment (S1) for the financial product. The product provider (10) generates an interest fee or premium payment (S3) for the financial product to a risk-taking entity (20). For cases where an insurance event occurred that is linked to the financial product, the risk-taking entity generates a bonus payment (S5) for the financial product. For cases where there is no occurrence of an insurance event that is linked to the financial product, the provider or the risk-taking entity generates a return interest payment (S7) for the financial product, the return interest payment being significantly lower than the bonus payment. Consequently, an investor (30) does not lose his principal payment but receives, in addition to the invested principal, at least a defined return interest payment when the respective insurance event does not occur, or a significant bonus payment when the respective insurance event does occur. Hence, there is an incentive for parties other than insurees to provide financial resources for the coverage of damages resulting from insurance events.

### FIELD OF THE INVENTION

The present invention relates to a computer system and a computer-implemented method for managing a financial product. Specifically, the present invention relates to a computer system and a computer-implemented method for managing a financial product linked to an insurance event such as a natural disaster, a man-made disaster and/or an event related to a life insurance risk.

### BACKGROUND OF THE INVENTION

Conventionally, insurance coverage for natural disasters such as earthquakes, typhoons or flood catastrophes is purchased by insurees through periodic payment of corresponding insurance premiums to an insurer. Typically, the insurer off-loads a part of the insured risk by purchasing re-insurance from a re-insurer. In these traditional models and systems, there is no incentive for parties other than insurees to provide financial resources for insurance coverage from natural disasters.

US 2006/0155628 describes a method of conducting a financial activity between a provider and a plurality of participants, based on a tropical weather event. According to US 2006/0155628 prediction data of a predicted outcome of a tropical weather event are obtained from participants. Moreover, investment funds from the participant are pooled in a common investment pool. Funds from the pool are distributed to participants who have provided prediction data that match external information about the respective tropical weather event. The method of US 2006/0155628 provides an incentive to participants other than insurees to provide financial resources to an investment pool related to natural disasters in the form of tropical weather events. However, a participant's financial investment may be lost completely or at least partly, if there is no match between the participant's prediction data and the actual tropical weather event. Furthermore, the method of US 2006/0155628 may be considered as monetary gambling not permitted in jurisdictions of some countries and/or states.

### SUMMARY OF THE INVENTION

It is an object of this invention to provide a computer system and a computer-implemented method for managing a financial product linked to a insurance event, which system and method do not have some of the disadvantages of the prior art. In particular, it is an object of the present invention to provide a computer system and a computer-implemented method for managing a financial product linked to an insurance event, such that there is an incentive for parties other than insurees to provide financial resources for the coverage of damages resulting from insurance events, while there is no risk to lose the financial investment when an insurance event occurs.

According to the present invention, these objects are achieved particularly through the features of the independent claims. In addition, further advantageous embodiments follow from the dependent claims and the description.

According to the present invention, the above-mentioned objects are particularly achieved in that, for managing a financial product linked to an insurance event, e.g. a natural disaster, a man-made disaster and/or an event related to a life insurance risk such as mortality or longevity, the product provider receives a principal payment for the financial product from an investor; the product provider generates an interest fee or premium payment for the financial product to a risk-taking entity such as a re-insurer or an insurer; the risk-taking entity generates a bonus payment for the financial product, for cases where an insurance event occurred that is linked to the financial product; and the product provider or the risk-taking entity generates a return interest payment for the financial product, for cases where no insurance event occurred that is linked to the financial product, the return interest payment being significantly lower than the bonus payment. For example, the natural disaster is an earthquake, a typhoon or a flood associated with one or more geographical areas, selectable by the investor.

Moreover, according to the present invention, the above-mentioned objects are particularly achieved in that, for managing the financial product linked to an insurance event, stored by a computer system is the principal payment received from the investor for the financial product. For example, the principal payment is a bank deposit or a fixed income note. Preferably, the computer system is associated with a provider of the financial product such as a depository bank, a note issuer, a national institution, or a supranational institution. Furthermore, received in the computer system is event information related to insurance events, e.g. event information related to occurrences of events of natural disasters. For cases where an insurance event occurred that is linked to the financial product, the computer system determines a bonus payment for the investor; on the other hand, for cases where no insurance event occurred that is linked to the financial product, the computer system determines a return interest payment for the investor. In a preferred embodiment, the bonus payment is significantly higher than the return interest payment, for example, the bonus payment is calculated as a defined percentage, e.g. in the range of 30%-50% of the principal payment, whereas the return interest payment, e.g. a fixed coupon, is calculated with a return interest rate higher than zero percent, e.g. in the range of 0.1%-0.5% of the principal payment or higher. In an alternative embodiment, however, a high coupon low bonus structure is implemented, e.g. if the yield curve changes. The investor's capital is guaranteed as the investor does not lose his principal but receives at least a defined return interest payment in addition to his principal. Hence, there is an incentive for parties other than insurees to provide financial resources for the coverage of insurance events, e.g. damages resulting from natural disasters. For financing the bonus payments and the return interest payment, the principal payments received from investors are invested.

In a preferred embodiment, generated by the computer system is an interest fee or premium payment for the financial product to a risk-taking entity. In exchange, for cases where an insurance event occurred that is linked to the financial product, the risk-taking entity pays the bonus for the investor of the financial product. Thus, stored by the computer system is a bonus payment from the risk-taking entity for the investor of the financial product. For example, the interest fee is the Libor interest rate (London Interbank Offered Rate) reduced by a defined number of base points, e.g. by 50 base points corresponding to a reduction of 0.5%. Consequently, the risk-taking entity needs to generate sufficient funds from the interest fees or premium payments to finance the bonus payment.

In an embodiment, in exchange of the interest fee or premium payment for the financial product, the risk-taking entity further pays the return interest payment for the investor of the financial product, for cases where no insurance event occurred that is linked to the financial product. Thus, further stored by the computer system is the return interest payment from the risk-taking entity for the investor of the financial product. Consequently, the risk-taking entity needs to generate sufficient funds from the interest fees or premium payments to finance the return interest payments or the bonus payment, in cases without or with an occurrence of an insurance event linked to the financial product, respectively.

In a preferred embodiment, the computer system generates a return payment to the investor within a defined maximum time period after occurrence of an insurance event that is linked to the financial product. Alternatively, when no insurance event occurred that is linked to the financial product, the computer system generates a return payment to the investor at a defined maturity of the financial product, e.g. the term of maturity is in the range of 2-5 years. For cases with occurrence of an insurance event linked to the financial product, the return payment includes the principal payment and the bonus payment. For cases without occurrence of an insurance event linked to the financial product, the return payment includes the principal payment and the return interest payment. In an alternative embodiment, the computer system generates the return payment to the investor also at the defined maturity of the financial product.

In a further embodiment, the event information includes geographical area and intensity values which represent at least one occurrence of an insurance event and trigger the determination and payout by the computer system of a bonus payment for the investor. For example, the event information includes identification information of geographically distributed earthquake measuring stations and measured seismic intensity values, which represent at least one occurrence of an earthquake event and trigger determination and payout by the computer system of a bonus payment for the investor. For example, the measured seismic intensity values are JMA instrumental intensity values (Japan Meteorological Agency) or JMA Shindo intensity values, which are based on the JMA instrumental intensity values. Such values are reported e.g. by JMA or NEID (National Research Institute for Earth Science and Disaster Prevention) after earthquake events on various media channels.

In addition to a computer system and a computer-implemented method for managing a financial product linked to a insurance event, the present invention also relates to a computer program product including computer program code means for controlling one or more processors of a computer system, particularly, a computer program product including a computer readable medium containing therein the computer program code means. The computer program code means are configured to control the processors such that the computer system stores a principal payment received from an investor of a financial product, receives event information related to occurrences of insurance events, and determines a bonus payment for the investor when an insurance event occurred that is linked to the financial product, and a return interest payment for the investor when no insurance event occurred that is linked to the financial product.

In a further aspect, the present invention further relates to a computer system for managing a financial product linked to an insurance event, the system comprising: a payment receiving module configured to receive a principal payment for the financial product from an investor; and a payment module configured to generate for the investor, based on the principal payment, a bonus payment, for cases where an insurance event occurred that is linked to the financial product, and a return interest payment, for cases where no insurance event occurred that is linked to the financial product.

In yet a further aspect, the present invention further relates to a computer-implemented method of managing a financial product linked to an insurance event, the method comprising: receiving a principal payment for the financial product from an investor; and generating for the investor, based on the principal payment, a bonus payment, for cases where an insurance event occurred that is linked to the financial product, and a return interest payment, for cases where no insurance event occurred that is linked to the financial product.

In a another aspect, the present invention further relates to a computer system for managing a financial product linked to an insurance event, the financial product being offered by a product provider to investors, and the system comprising: a payment receiving module configured to receive for the financial product a principal payment from an investor to the product provider; a premium payment module configured to generate for the financial product an interest fee or premium payment from the product provider to a risk-taking entity; a return payment module configured to generate a bonus payment from the risk-taking entity for the financial product, for cases where an insurance event occurred that is linked to the financial product; and a payment module configured to generate a return interest payment from the provider or the risk-taking entity for the financial product, for cases where no insurance event occurred that is linked to the financial product, the return interest payment being significantly lower than the bonus payment.

In yet another aspect, the present invention further relates to a computer-implemented method of managing a financial product linked to an insurance event, the financial product being offered by a product provider to investors, the method comprising: receiving by the product provider a principal payment for the financial product from an investor; generating by the product provider an interest fee or premium payment for the financial product to a risk-taking entity; generating by the risk-taking entity a bonus payment for the financial product, for cases where an insurance event occurred that is linked to the financial product; and generating by the provider or the risk-taking entity a return interest payment for the financial product, for cases where no insurance event occurred that is linked to the financial product, the return interest payment being significantly lower than the bonus payment.

### BRIEF DESCRIPTION OF THE DRAWINGS

The present invention will be explained in more detail, by way of example, with reference to the drawings in which:

FIG. 1 shows a block diagram illustrating schematically an exemplary configuration of a computer system for practicing embodiments of the present invention, said computer system being accessible to investors.

FIG. 2 shows a flow diagram illustrating an example of a sequence of monetary and/or information flow executed according to the present invention.

### DETAILED DESCRIPTION OF THE PREFERRED EMBODIMENTS

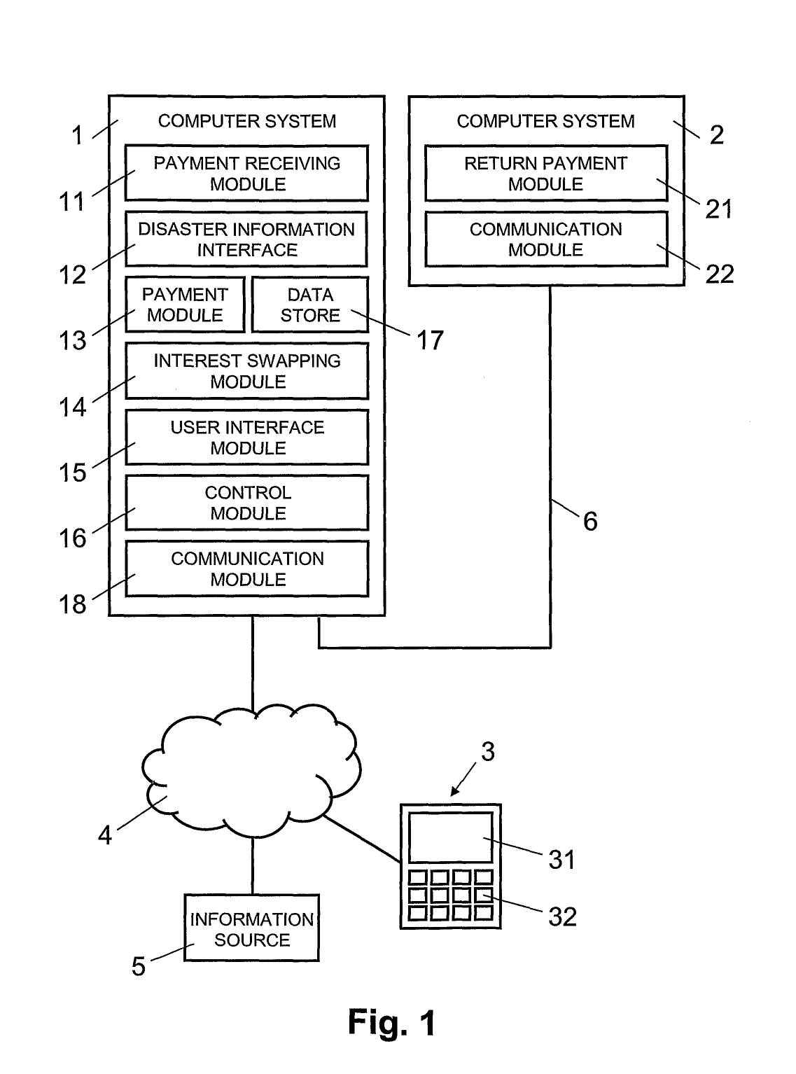

In FIG. 1, reference numeral 1 refers to a computer system including one or more computers, for example personal or server computers, each comprising one or more processors. Computer system 1 is associated with a provider of a financial product, e.g. a product provider 10 such as a depository bank, a note issuer, a national institution, or a supranational institution.

As is illustrated schematically in FIG. 1, computer system 1 further includes various functional modules, namely a payment receiving module 11, a disaster information interface 12, a payment module 13, an interest swapping module 14, a user interface module 15, a control module 16 and a communication module 18. Preferably, the functional modules are implemented as programmed software modules. The computer program code of the software modules is stored in a computer program product, i.e. in a computer readable medium, either in memory integrated in a computer of computer system 1 or on a data carrier that can be inserted into a computer of computer system 1. Alternatively, the functional modules are implemented partly or fully by means of hardware components.

The reference numeral 3 refers to a communication terminal having a display 31 and a keyboard 32, e.g. a personal computer, a laptop computer, a mobile radio telephone or a personal digital assistant. As shown schematically in FIG. 1, computer system 1 is accessible via telecommunication network 4 for a plurality of investors using their communication terminals 3. Telecommunication network 4 includes fixed networks and/or wireless networks. For example, telecommunication network 4 includes a local area network (LAN), an integrated services digital network (ISDN), the Internet, a global system for mobile communication (GSM), a universal mobile telephone system (UMTS) or another mobile radio telephone system, and/or a wireless local area network (WLAN). Communication module 18 is configured to enable data communication between computer system 1 and communication terminal 3. In an embodiment, communication module 18 further includes an interactive voice response module or a voice recognition module configured to receive investor instructions per voice and/or menu driven key input.

Reference numeral 2 refers to a further computer system including one or more computers comprising one or more processors. Computer system 2 is associated with and representative of a risk-taking entity 20, e.g. a re-insurer or an insurer. Computer system 2 further includes various functional modules, namely a return payment module 21 and a communication module 22. Preferably, these functional modules are implemented as programmed software modules as described above. Alternatively, the functional modules are implemented partly or fully by means of hardware components. As is illustrated schematically, computer systems 1 and 2 are interconnected through a data communication link 6, e.g. a data connection established through telecommunications network 4 or the like.

Reference numeral 5 refers to an information source providing event information about occurrences of insurance events, e.g. occurrences of events of natural disasters such as earthquakes, typhoons or floods. Depending on the implementation and/or type of insurance event, information source 5 is a computer-based database updated periodically or continuously with event information from a plurality of measuring and/or reporting stations. Alternatively, information source 5 is representative of a plurality of computerized measuring and/or reporting stations providing current event information for a defined geographical area, for instance. The event information includes identification information about a plurality of geographical areas and/or a geographically distributed measuring and/or reporting stations, e.g. earthquake measuring stations, weather stations and/or water level measuring stations. Moreover, the event information includes intensity values representative of at least one occurrence of an insurance event, e.g., in the case of a natural disaster, seismic intensity values such as JMA instrumental intensity values or JMA Shindo intensity values, wind speed or water levels.

The disaster information interface 12 is configured to retrieve and receive the disaster event information automatically and proactively from information source 5, e.g. in a periodic pull mode, or as provided automatically by information source 5 in push mode. Alternatively, disaster event information may be loaded manually, e.g. using a keyboard, or as batch files through disaster information interface 12.

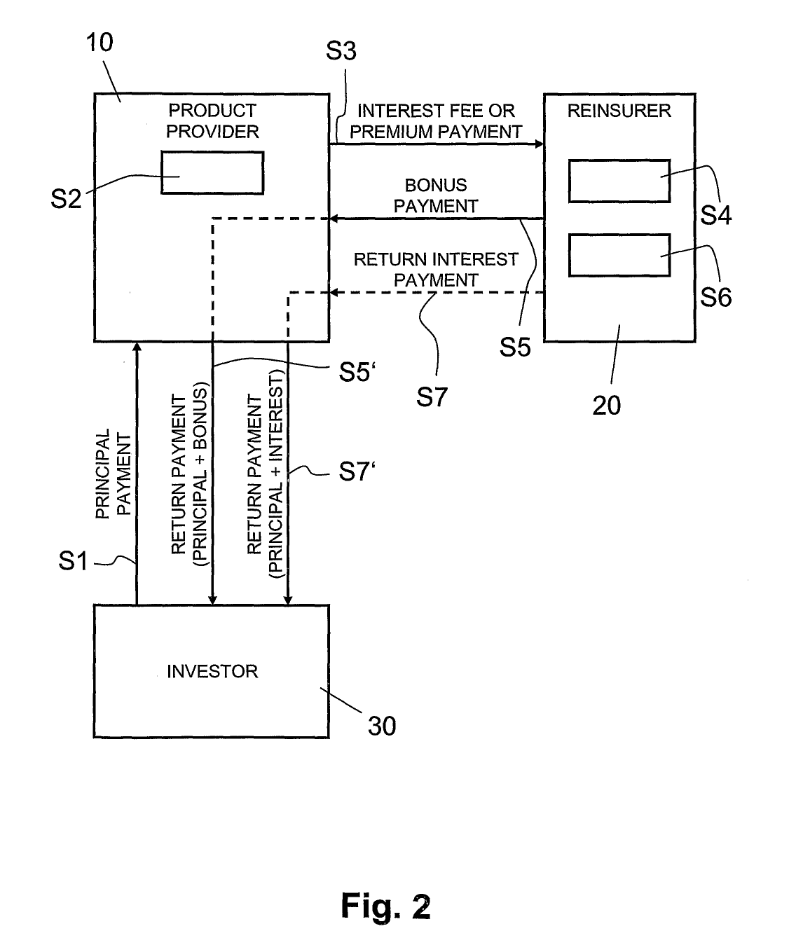

In the following paragraphs, described with reference to FIG. 2 is an exemplary sequence of data flow, representative of monetary flow, executed according to the present invention.

In step S1, an investor 30 makes a principal payment for a selected financial product to the product provider 10. For example, the principal payment is selected from various options, e.g. 1, 2, 5, 10, 25 millions, of a selected currency, e.g. USD or JPY. The selected financial product is linked to a specific type of an insurance event for one or more specified geographical areas or geographically distributed measuring stations, e.g., in the case of earthquakes, selected JMA Shindo stations. In an embodiment, user interface module 15 is configured to receive from the investor instructions for selecting a financial product and one or more geographical areas or measuring stations, respectively, to be associated with the financial product. For example, the user selection of a geographical area and/or measuring station is implemented as an option, available to the investor 30 depending on the amount of principal that he desires to invest. Defined by user interface module 15, the user interface is visualized on display 31 of communication terminal 3 and includes graphical user interfaces, forms and/or web pages in the form of HTML (Hypertext Markup Language) or XHTML (Extended Hypertext Markup Language), for example. Preferably, the financial product and the principal payment are specified to the product provider's computer system 1 using communication terminal 3 to access user interface module 15. However, one skilled in the art will understand that the financial product and the principal payment can be specified by an investor using alternative communication channels, such as e-mail, fax, paper or even verbal communication in combination with respective conversion and data entry modules at computer system 1. In addition to the type of an insurance event and geographical area, the financial product is further specified by its term of maturity, e.g. 2-5 years, its guaranteed return interest rate, e.g. a fixed coupon of 0.1%, and its bonus payment as a defined percentage of the principal payment, e.g. 50%. A higher guaranteed return interest rate, e.g. 0.5%, may be available for a reduced bonus percentage, e.g. 30%. In an embodiment, the bonus percentage is variable and depends on the magnitude of the insurance event, e.g. the magnitude of the natural disaster.

In step S2, control module 16 stores, assigned to the investor, the information about the selected and thus purchased financial product in a data store 17 of computer system 1. Moreover, the control module 16 debits a financial account of the investor with the principal amount. Control module 16 is also configured to check and verify identity and authenticity of the investor, prior to accepting any instructions. In an embodiment, control module 16 also groups and aggregates corresponding financial products (e.g. same type of insurance event, same geographical area, and same maturity term) for subsequent purchase of insurance or re-insurance, as outlined below.

In step S3, for the financial product selected (i.e. purchased) by the investor, the product provider 10 makes a payment of an interest fee or a premium to the risk-taking entity 20. Through payment of the interest fee or a premium payment, the product provider 10 purchases insurance or re-insurance for the financial product from the risk-taking entity 20. In other words, the product provider 10 off-loads to the risk-taking entity 20 the risk of having to make a bonus payment in case of an occurrence of an insurance event linked to the financial product. While the interest fee corresponds to a defined percentage of the principal amount associated with the financial product, the premium payment is calculated from the principal amount by another defined percentage of the principal amount. For example, the interest fee is based on the Libor interest rate reduced by a defined number of base points, e.g. by 50 base points corresponding to a reduction of 0.5%. Depending on the implementation, the interest fee or a premium payment from the product provider 10 to the risk-taking entity 20 is generated by interest swapping module 14 and executed as an actual individual transaction between computer system 1, associated with the product provider 10, and computer system 2, associated with the risk-taking entity 20, i.e. the risk-taking entity; or as local transaction in an accounting database of computer system 1, conveyed to computer system 2 together with other transactions, e.g. as part of batch processing. One skilled in the art will understand that financial transactions between product provider 10 and risk-taking entity 20 may be performed via a third party such as a financial institution or clearance center.

In step S4, in the case that within the term of maturity of the financial product an insurance event occurred that is linked to the financial product, the risk-taking entity 20 generates a bonus payment for the respective financial product. For example, the bonus payment is generated by the re-insurance payment module 21. Using a defined bonus rate associated with the financial product, e.g. in the range of 30%-50%, the bonus payment is calculated, e.g. by the re-insurance payment module 21 or the payment module 13, as a defined percentage of the principal associated with the financial product. The bonus payment is made to the investor 30 within a defined maximum time period, e.g. 45 days, after the respective insurance event. Preferably and depending on the conditions of the financial product, the product provider 10 pays back to the investor 30 the principal together with the bonus payment. Thus, the payment module 13 generates for the investor 30 a return payment that includes the principal and the bonus payment associated with the financial product. In an embodiment, principal returns are paid periodically. Depending on the implementation, the bonus payment is made by the risk-taking entity in step S5 to the product provider 10 where it is received by interest swapping module 14 and forwarded to the investor 30 in step S5′, or the bonus payment is made by the product provider 10 directly to the investor 30 and claimed by the product provider 10 from the risk-taking entity 20. For example, the bonus payment is executed as an actual individual transaction between computer system 2 associated with the risk-taking entity 20 and computer system 1 associated with the product provider 10; or as local transaction in an accounting database of computer system 2, conveyed to computer system 1 together with other transactions, e.g. as part of batch processing. One skilled in the art will understand that financial transactions between the risk-taking entity 20 and the investor 30, as well as between the investor 30 and the investor 30, may be performed via a third party such as a financial institution or clearance center.

In step S6, in the case that within the term of maturity of the financial product there was no occurrence of an insurance event that is linked to the financial product, the risk-taking entity 20 or the product provider 10 generates a return interest payment for the respective financial product. In an embodiment, the risk-taking entity 20 or the product provider 10 generates a return interest payment for the respective financial product independently of whether or not an insurance event occurred within the term of maturity, i.e. in this embodiment, the return interest payment is generated and paid for the respective financial product regardless of the occurrence of an insurance event. Using a defined return interest rate associated with the financial product, e.g. in the range of 0.1% to 0.5% or higher, the return interest payment is calculated and generated, e.g. by the re-insurance payment module 21 or the payment module 13, as a defined percentage of the principal associated with the financial product. The return interest payment is made to the investor 30 at maturity of the financial product. The product provider 10 pays back to the investor 30 the principal together with the return interest payment. Thus, the payment module 13 generates for the investor 30 a return payment that includes the principal and the return interest payment associated with the financial product. In an embodiment, principal returns are paid periodically. Depending on the implementation, the return interest payment is made by the risk-taking entity in step S7 to the product provider 10 where it is received by interest swapping module 14 and forwarded to the investor 30 in step S7′, or the return interest payment is made by the product provider 10 directly to the investor 30 and, if applicable, claimed by the product provider 10 from the risk-taking entity 20. For example, the return interest payment is executed as an actual individual transaction between computer system 2 associated with the risk-taking entity 20 and computer system 1 associated with the product provider 10; or as local transaction in an accounting database of computer system 2, conveyed to computer system 1 together with other transactions, e.g. as part of batch processing.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. Specifically, in the description, the computer program code has been associated with specific software modules, one skilled in the art will understand, however, that the computer program code may be structured differently, without deviating from the scope of the invention. In addition, as some of the steps may be performed in computer system 1 associated with the product provider 10 and/or in the computer system 2 associated with the risk-taking entity 20, e.g. the bonus payment or the return interest payment may be determined and/or generated by computer system 1 and/or 2, the term “computer system” as used in the claims may in some embodiments refer to a computer system that comprises computer system 1 and 2, although generally, the term “computer system” relates to computer system 1. Furthermore, the particular order of the steps set forth in the specification should not be construed as limitations on the claims.

What is claimed is:

1. A computer system for managing a financial product linked to an insurance event, the system comprising:
a payment receiving module configured to receive and store a principal payment from an investor for the financial product;
a disaster information interface configured to receive event information related to occurrences of insurance events; and
a payment module configured to determine a bonus payment for the investor when an insurance event occurred that is linked to the financial product, and a return interest payment for the investor when no insurance event occurred that is linked to the financial product.

2. The system of claim 1, further comprising an interest swapping module configured to generate an interest fee or premium payment for the financial product to a risk-taking entity, and to receive a bonus payment from the risk-taking entity for the investor of the financial product when an insurance event occurred that is linked to the financial product.

3. The system of claim 2, wherein the interest swapping module is configured to calculate the interest fee by reducing the Libor interest rate by a defined number of base points.

4. The system of claim 2, wherein the interest swapping module is further configured to receive a return interest payment from the risk-taking entity for the investor of the financial product when no insurance event occurred that is linked to the financial product.

5. The system of claim 1, wherein the payment module is configured to calculate the bonus payment as a defined percentage of the principal payment.

6. The system of claim 1, wherein the payment module is further configured to generate a return payment to the investor within a defined maximum time period after occurrence of an insurance event that is linked to the financial product, the return payment including the principal payment and the bonus payment; and to generate a return payment to the investor at a defined maturity of the financial product when no insurance event occurred that is linked to the financial product, the return payment including the principal payment and the return interest payment.

7. The system of claim 1, wherein the payment module is further configured to generate a return payment to the investor at a defined maturity of the financial product, the return payment including the principal payment, the bonus payment and/or the return interest payment.

8. The system of claim 1, wherein the financial product is linked to a natural disaster comprising at least one of earthquake, typhoon, and flood.

9. The system of claim 1, wherein the financial product is linked to a natural disaster associated with at least one geographical area.

10. The system of claim 9, further comprising a user interface module configured to receive from the investor instructions for selecting the at least one geographical area.

11. The system of claim 1, wherein the event information includes geographical area and intensity values which represent at least one occurrence of an insurance event and trigger determination and payout by the computer of a bonus payment for the investor.

12. The system of claim 1, wherein the event information includes identification information of geographically distributed earthquake measuring stations and measured seismic intensity values which represent at least one occurrence of an insurance event and trigger determination and payout by the computer of a bonus payment for the investor.

13. The system of claim 1, wherein the financial product is linked to an insurance event including at least one of a natural disaster, a man-made disaster, and an event related to a life insurance risk; the financial product is associated with a term of maturity of 2-5 years, a return interest rate of the return interest payment is higher than zero percent; a rate of the bonus payment is in a range of 30%-50%; the return interest payment is a fixed coupon; the principal payment includes at least one of bank deposits and fixed income notes; and the computer system is associated with one of a depository bank, a note issuer, a national institution, and a supranational institution.

14. A computer-implemented method of managing a financial product linked to an insurance event, the method comprising:
storing by a computer system a principal payment received from an investor for the financial product;
receiving in the computer system event information related to occurrences of insurance events; and
determining by the computer system a bonus payment for the investor when an insurance event occurred that is linked to the financial product, and a return interest payment for the investor when no insurance event occurred that is linked to the financial product.

15. The method of claim 14, further comprising generating by the computer system an interest fee or premium payment for the financial product to a risk-taking entity; and storing by the computer system a bonus payment from the risk-taking entity for the investor of the financial product when an insurance event occurred that is linked to the financial product.

16. The method of claim 15, wherein the interest fee is calculated by reducing the Libor interest rate by a defined number of base points.

17. The method of claim 15, further comprising storing by the computer system a return interest payment from the risk-taking entity for the investor of the financial product when no insurance event occurred that is linked to the financial product.

18. The method of claim 14, wherein the bonus payment is calculated as a defined percentage of the principal payment.

19. The method of claim 14, further comprising generating by the computer system a return payment to the investor within a defined maximum time period after occurrence of an insurance event that is linked to the financial product, the return payment including the principal payment and the bonus payment; and generating by the computer system a return payment to the investor at a defined maturity of the financial product when no insurance event occurred that is linked to the financial product, the return payment including the principal payment and the return interest payment.

20. The method of claim 14, further comprising generating by the computer system a return payment to the investor at a defined maturity of the financial product, the return payment including the principal payment, the bonus payment and/or the return interest payment.

21. The method of claim 14, wherein the financial product is linked to a natural disaster comprising at least one of earthquake, typhoon and flood.

22. The method of claim 14, wherein the financial product is linked to a natural disaster associated with at least one geographical area.

23. The method of claim 22, wherein the at least one geographical area is selectable by the investor.

24. The method of claim 14, wherein the event information includes geographical area and intensity values which represent at least one occurrence of an insurance event and trigger determination and payout by the computer system of a bonus payment for the investor.

25. The method of claim 14, wherein the event information includes identification information of geographically distributed earthquake measuring stations and measured seismic intensity values which represent at least one occurrence of an insurance event and trigger determination and payout by the computer system of a bonus payment for the investor.

26. The method of claim 14, wherein the financial product is linked to an insurance event including at least one of a natural disaster, a man-made disaster, and an event related to a life insurance risk; the financial product is associated with a term of maturity of 2-5 years; a return interest rate of the return interest payment is higher than zero percent; an interest rate of the bonus payment is in a range of 30%-50%; the return interest payment is a fixed coupon; the principal payment includes at least one of bank deposits and fixed income notes; and the computer system is associated with one of a depository bank, a note issuer, a national institution, and a supranational institution.

27. A computer program product comprising a computer-readable medium with computer program code means for controlling one or more processors of a computer system for managing a financial product linked to an insurance event, such that the computer system:
stores a principal payment received from an investor for the financial product;
receives event information related to occurrences of insurance events; and
determines a bonus payment for the investor when an insurance event occurred that is linked to the financial product, and a return interest payment for the investor when no insurance event occurred that is linked to the financial product.

28. The computer program product of claim 27, comprising further computer program code means for controlling the processors of the computer system, such that the computer system generates an interest fee or premium payment for the financial product to a risk-taking entity, and stores a bonus payment from the risk-taking entity for the investor of the financial product when an insurance event occurred that is linked to the financial product.

29. The computer program product of claim 28, comprising further computer program code means for controlling the processors of the computer system, such that the computer system stores a return interest payment from the risk-taking entity for the investor of the financial product when no insurance event occurred that is linked to the financial product.

30. The computer program product of claim 27, comprising further computer program code means for controlling the processors of the computer system, such that the computer system generates a return payment to the investor within a defined maximum time period after occurrence of an insurance event that is linked to the financial product, the return payment including the principal payment and the bonus payment; and generates a return payment to the investor at a defined maturity of the financial product when no insurance event occurred that is linked to the financial product, the return payment including the principal payment and the return interest payment.

31. A computer system for managing a financial product linked to an insurance event, the system comprising:
a payment receiving module configured to receive a principal payment for the financial product from an investor; and
a payment module configured to generate for the investor, based on the principal payment, a bonus payment, for cases where an insurance event occurred that is linked to the financial product, and a return interest payment, for cases where no insurance event occurred that is linked to the financial product.

32. A computer-implemented method of managing a financial product linked to an insurance event, the method comprising:
receiving a principal payment for the financial product from an investor; and
generating for the investor, based on the principal payment, a bonus payment, for cases where an insurance event occurred that is linked to the financial product, and a return interest payment, for cases where no insurance event occurred that is linked to the financial product.

33. A computer system for managing a financial product linked to an insurance event, the financial product being offered by a product provider to investors, the system comprising:
a payment receiving module configured to receive for the financial product a principal payment from an investor to the product provider;
an interest swapping module configured to generate for the financial product an interest fee or premium payment from the product provider to a risk-taking entity;
a return payment module configured to generate a bonus payment from the risk-taking entity for the financial product, for cases where an insurance event occurred that is linked to the financial product; and
a payment module configured to generate a return interest payment from the provider or the risk-taking entity for the financial product, for cases where no insurance event occurred that is linked to the financial product, the return interest payment being significantly lower than the bonus payment.

34. A computer-implemented method of managing a financial product linked to an insurance event, the financial product being offered by a product provider to investors, the method comprising:
receiving by the product provider a principal payment for the financial product from an investor;
generating by the product provider an interest fee or premium payment for the financial product to a risk-taking entity;
generating by the risk-taking entity a bonus payment for the financial product, for cases where an insurance event occurred that is linked to the financial product; and
generating by the provider or the risk-taking entity a return interest payment for the financial product, for cases where no insurance event occurred that is linked to the financial product, the return interest payment being significantly lower than the bonus payment.
